(19) United States
(12) Patent Application Publication
(10) Pub. No.: US 2016/0164882 A1
(43) Pub. Date: Jun. 9, 2016

(54) Verification Code Generating System And Method

(71) Applicants: Inventec (Pudong) Technology Corporation, Shanghai (CN); Inventec Corporation, Taipei City (TW)

(72) Inventor: Long Chen, Shanghai (CN)

(21) Appl. No.: 14/662,980

(22) Filed: Mar. 19, 2015

(30) Foreign Application Priority Data
Dec. 5, 2014 (CN) 201410740927.9

(51) Int. Cl. H04L 29/06

(52) U.S. Cl. CPC H04L 63/12; H04L 63/083

(57) ABSTRACT

A verification code generating system and method are provided, where a difference of a displayed verification code and an inputted verification code are recorded as the error-prone message for an account, when a password is correct while the verification code is wrong, and an exclusive verification code is generated according to the error-prone message according to the account when the same account logins again, whereby the technical efficacy of an enhanced verification code recognition is achieved.

### CROSS-REFERENCE TO RELATED APPLICATION

This application claims the benefit of Chinese Patent Application No. 201410740927.9, filed Dec. 5, 2014.

### BACKGROUND OF THE RELATED ART

1. Technical Field

The present invention relates to a generating system and method, and particularly to a verification code generating system and method based on user recognition ability.

2. Related Art

For recent years, various login application service used on mobile devices have been widely developed with prevalence of the mobile devices.

Generally, for exemption from a crack in a form of an automatic evil program login, it is typically required a user to input a verification code message consistent to a randomly generated verification code, so as to ascertain that this login operation is not made by an automation robot.

However, the currently available evil program has been developed into equipping with preliminary graphic recognition ability, and is further able to automatically recognizing and inputting the verification code. In response, the verification code recognition is further imposed with an increased challenge by introducing a recognition increasing technology such as a distortion, color varying, noise interference, etc. However, such manner has simultaneously increased the recognition for the actual user. For those apt to be confused characters, the recognition difficulty them is further increased, such the letter “q” and the number “9”, the letter “o” and the number “0”. Therefore, there is the issue of poor verification code recognition. In view of this problem, there has been the technology providing a question seeking a corresponding answer implemented, e.g. a mathematical operation equation is given to acquire an operational result as the verification code. However, it may be a trouble to those incapable of responding a right answer, such as those having a poor mathematical operational ability. Therefore, the poor verification code recognition still leaves something to be considered.

In view of the above, it may be known that there has long been the issue of poor verification code recognition in the prior art, it is therefore quite a need to set forth an improvement means to settle down this problem.

### SUMMARY

It is, therefore, an object of the present invention to provide a verification code generating system and method.

According to the present invention, the verification code generating system comprises a store module, storing at least an account therein, each of the account comprising an error-prone message; an operating module, generating and displaying a verification code and receiving a verification code message; a record module, recording a difference between the verification code message and the verification code, if the difference exists, into the error-prone message corresponding to the account when a user logins one of the account; and a generation module, generating an exclusive verification code according to the error-prone message of the account when the user logins the same account, and using the exclusive verification code as the verification code to be display.

According to the present invention, the verification code generating method comprising steps of storing at least an account therein, each of the account comprising an error-prone message; generating and displaying a verification code and receiving a verification code message; recording a difference between the verification code message and the verification code, if the difference exists, into the error-prone message corresponding to the account when a user logins one of the account; and generating an exclusive verification code according to the error-prone message of the account when the user logins the same account, and using the exclusive verification code as the verification code to be display.

The system and method of the present invention has the difference as compared to the prior art that the difference of the displayed verification code and the inputted verification code is recorded as the error-prone message for the account when the password inputted is correct while the verification code inputted is wrong, and the exclusive verification code is generated as the verification code according to the error-prone message of the account when the same accounts logins again.

By using the technical means, the present invention may well achieve the technical efficacy of an enhanced verification code recognition.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a system block diagram of a verification code generating system according to the present invention;

FIG. 2 is a flowchart of a verification code generating method according to the present invention;

FIG. 3A and FIG. 3B are a schematic diagram illustrating a login operation using the present invention, respectively; and

FIG. 4 is a schematic diagram illustrating a generation for an exclusive verification code by using the present invention.

### DETAILED DESCRIPTION

The present invention will be apparent from the following detailed description, which proceeds with reference to the accompanying drawings, wherein the same references relate to the same elements.

Prior to the description to the verification code generating system and method of the present invention, the noun exclusively defined in this invention will be first described. An error-prone message is recorded with some characters of a verification code prone to be erroneously inputted by the user, which may be, in other words, characters forming a recognition hinder to the user. For example, when the error-prone message is recorded as “q; 9”, it is represented that when the verification code displays the letter “q”, a number inputted by the user is “9”. In addition, the exclusive verification code only includes those characters exempting from the recognition hinder, which will be described in more detail with reference to figures.

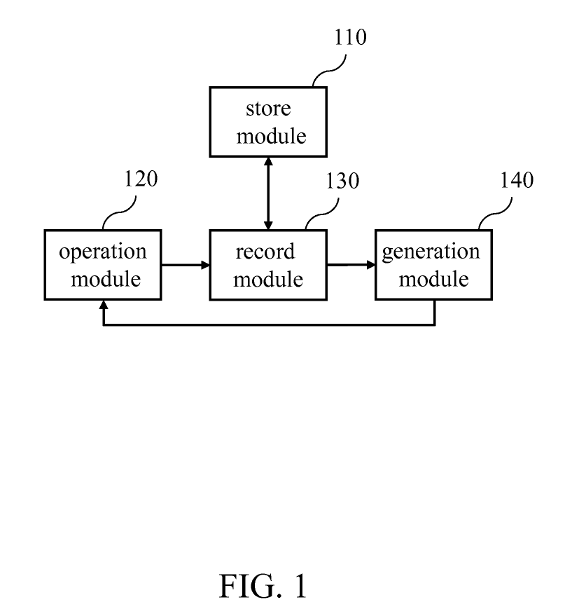

In the following, the verification code generating system and method are described in more detail. Referring first to FIG. 1, a system block diagram of the verification code system is illustrated therein. The system comprises a store module 110, an operation module 120, a record module 130, and generation module 140. The store module 110 is used to store a plurality of accounts, in which each of the accounts comprises an error-prone message. In real implementation, the store module 110 may be a correspondence database. The error-prone message may comprise a character, a number, a symbol, and a color including a foreground color and a background color. Since the error-prone message has been explained as privately define in the present invention as the above, the description for it is omitted herein.

The operation module 120 is used to generate and display the verification code, and receive a verification code message. In real implementation, the operation module 120 may randomly generate the verification code to be displayed at an initial stage, so that a user may be prompted to input the verification code message which is consistent with the displayed verification code. The generated verification code may be a combination and arrangement of any characters, and may have its foreground color and background color.

The record module 130 is used to record a difference between the verification code message and the verification code, when one of the accounts login and a password inputted at this time is correct. For example, assume the verification code is “oa123”, the verification code message is “0a123”, the difference between the two will be recorded into the error-prone message corresponding to the account, i.e. the letter “o” in the verification code and the number “0” in the verification code message. It is to be particularly pointed out that the difference is stopped for being recorded into the error-prone message when a total number of the difference between the verification code and the verification code message goes beyond a predetermined proportion of a total character number, e.g. 60%. And the predetermined proportion may be adjusted after the account logins.

The generation module 140 is used to generate an exclusive verification code according to the error-prone message comprised in the account, when it logins to the same account again. In real implementation, the generation module 140 may screen out some characters comprised in the error-prone message corresponding to the account and launch an arbitrary arrangement and combination for the remaining characters in the error-prone message. Further, these characters remaining in the error-prone message may be arbitrarily set with their respective foreground color and background color for forming the exclusive verification code. For the scene colors, the foreground color may be represented by a color code in a hexadecimal form “#RRGGBB”, such as “#FF0000” represents red, “#00FF00” represents green, and “#0000FF” represents blue. ° In addition, the error-prone message may further comprise a weight for each of its characters. Now the above mentioned error-prone message is taken as an example, it may be also recorded as “o,5;0,4”, where the numbers “5” and “4” are each the corresponding weight. The weights may be arranged as from high to low and which indicates a recognizable extent from high to low, which is merely an example without limiting the present invention. The weight may be employed as a basis for screening out some characters. For example, it may select to screen out the characters which are larger than “4” in number, namely the character “o” is to be screened out in the above example. Hence, the character “o” will not appear in the generated exclusive verification code. It is to be particularly pointed out that an appropriate time span maybe set together when the user logins with his/her account, such as more than 10 seconds for exemption from an automation robot's login repeatedly within a short time span.

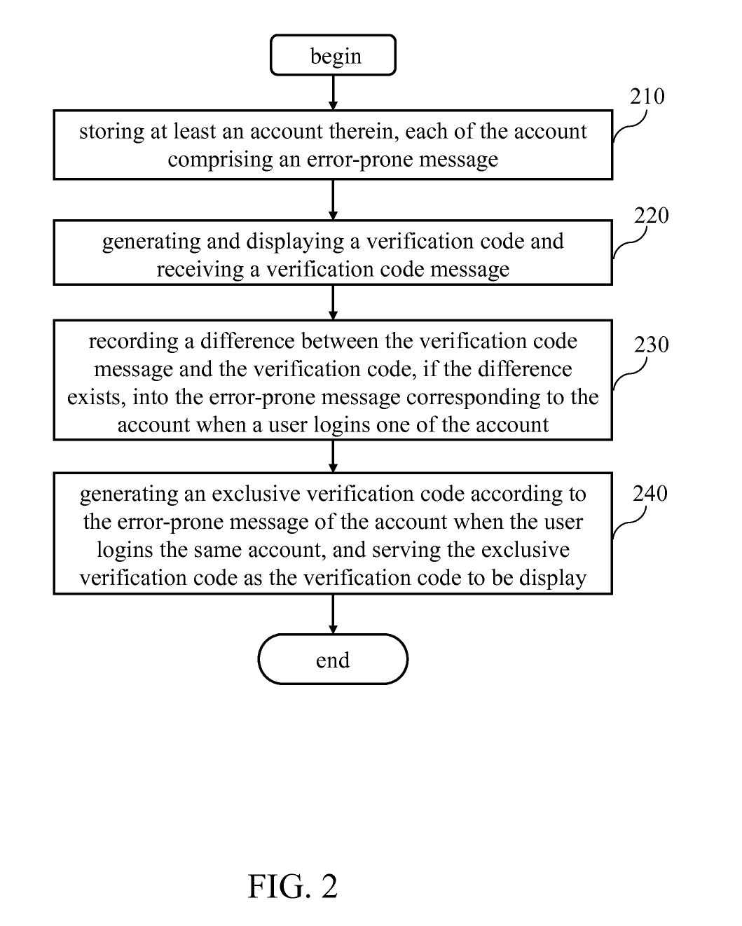

Thereafter, referring to FIG. 2, a flowchart of a verification code generating method according to the present invention is shown therein. The method comprises the following steps. Firstly, at least an account is stored previously, wherein each of the accounts comprises an error-prone message (Step 210). Next, a verification code is generated and displayed and a verification code message is received (Step 220). Thereafter, when one of such accounts logins, a difference between the verification code message and the verification code, if the difference exists, is recorded into the error-prone message corresponding to the account (Step 230). Finally, an exclusive verification code is generated according to the error-prone message of the account when the user logins the same account again, and the exclusive verification code is served as the verification code to be displayed (Step 240). By performing the above steps, after one of these accounts logins, the difference of the displayed verification code and the inputted verification code is recorded as the error-prone message for the account when the password inputted is correct and the exclusive verification code is generated as the verification code according to the error-prone message of the account when the same accounts logins again.

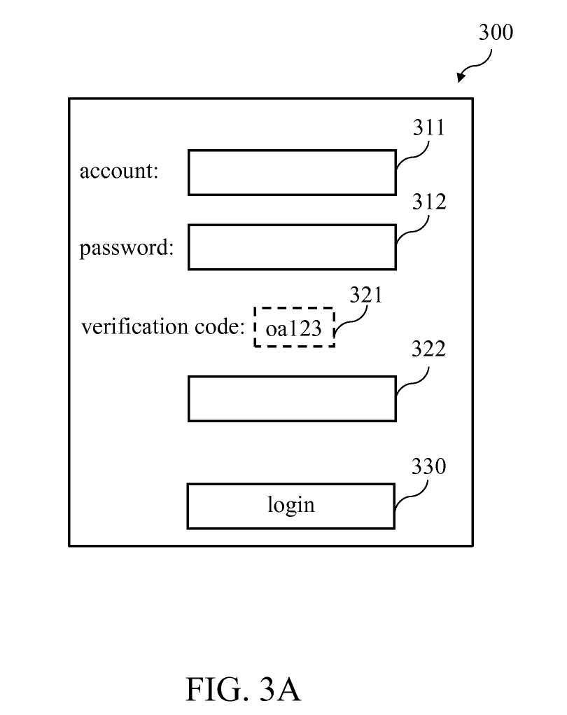

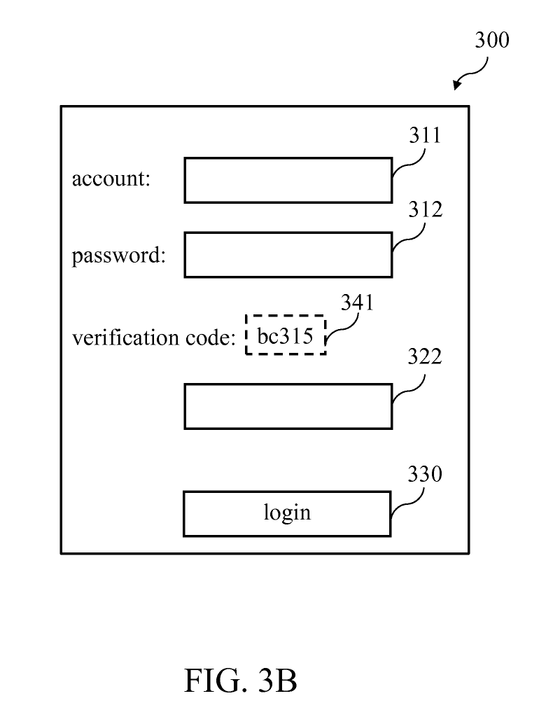

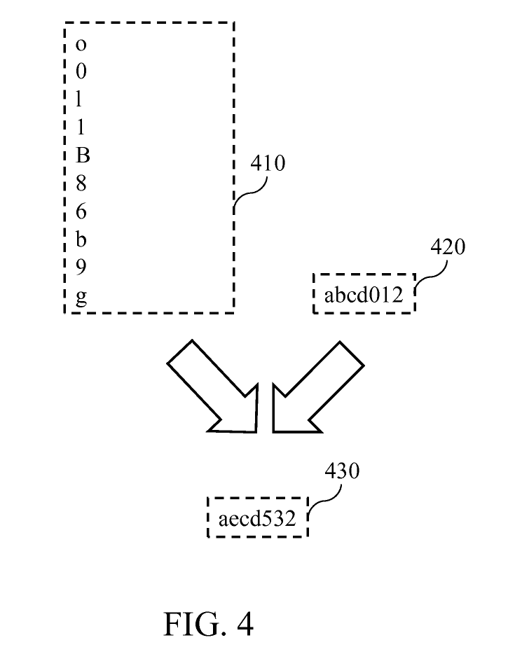

In the following, FIG. 3A through FIG. 4 are illustrated to describe the present invention by using an embodiment. Referring first to FIG. 3A and FIG. 3B, a schematic diagram illustrating a login operation using the present invention is shown therein, respectively. As shown in FIG. 1, the login interface 300 has an account input frame 311 for an input of an account, a password input frame 312 for an input of a password, and a verification code input frame 322 for an input of a verification code message consistent to the verification code 321. The verification code 321 is generated previously before the login interface 300 is activated and then displayed. Thereafter, the user logins by his/her account for a later processing by using his cursor clicking a login component 330. In response, the operation module 120 receives the verification code message keyed in by the user from the verification code input frame 322. In the above example, since the verification code 321 is “oa123”, assume the verification code message inputted by the user is also “oa123”, then the account login process is finished when the account and password are both examined as being correct. Otherwise, assume the account and password are both correct, since the verification code message has a difference with respect to the verification code 321, in which the verification code message inputted by the user is “0a123”, the record module 130 will record the difference into the error-prone message corresponding to this account. Further, the same login interface 300 is provided to enable the user to login again by using the same account, as is shown in FIG. 3. However, the generation module 140 may generate the exclusive verification code according to the error-prone message (for excluding the verification codes generated from the letter “o” and the number “0”), such as “bc315”, and take this exclusive verification code as the verification code 341 to be displayed. In such manner, the user may be shown with a verification code which may not cause a difficulty for recognition when he/she logins again, whereby a possibility of a wrong input by the user may be achieved.

As shown in FIG. 4, a schematic diagram illustrating a generation for an exclusive verification code by using the present invention is shown therein. Assume the error-prone message 410 for some account has a plurality of characters are recorded therein, such as “o”, “0”, “1”, “1”, “B”, “8”, “6”, “b”, “9” and “g” now. The generation module 140 may arbitrarily arrange and combine any characters 420 previously, and exclude some characters from and according to the error-prone message corresponding to the account, so as to generate the exclusive verification code 430. In real implementation, each of the characters recorded in the error-prone message 410 may comprise a weight for it, and the less the weight is, the lower recognition ability corresponding thereto is. Therefore, the generation module 140 may also exclude some characters from the error-prone message according to the predetermined weights. For example, a character having a weight of “5” is excluded. In addition, assume the verification code has its color, then each of the characters may record a color code represented by a hexadecimal number, such as “o,#FF0000”, representing that the user may have a recognition problem when the letter “o” appear as red. In this manner, the red letter “o” will be excluded from the exclusive verification code. As such, any character might arise a recognition problem for different users may be effectively avoided being used in the generated exclusive verification code.

In summary, it may be known that there is a difference of the present invention as compared to the prior art that the difference of the displayed verification code and the inputted verification code are recorded as the error-prone message for the account when the password inputted is correct while the verification code inputted is wrong, and the exclusive verification code is generated as the verification code according to the error-prone message of the account when the same accounts logins again. By using this technical means, the issue encountered in the prior art may be solved, and thus the technical efficacy of an enhanced verification code recognition may be achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A verification code generating system, comprising:
a store module, storing at least an account therein, each of the account comprising an error-prone message;
an operating module, generating and displaying a verification code and receiving a verification code message;
a record module, recording a difference between the verification code message and the verification code, if the difference exists, into the error-prone message corresponding to the account when a user logins one of the account; and
a generation module, generating an exclusive verification code according to the error-prone message of the account when the user logins the same account again, and using the exclusive verification code as the verification code to be displayed.

2. The verification code generating system as claimed in claim 1, wherein the error-prone message comprises a character, a number, a symbol, and a color, the color comprising a foreground color and a background color.

3. The verification code generating system as claimed in claim 1, wherein the generation module screens out a character portion from the error-prone message having a plurality of characters included in the account into a screened character content and re-arranging a remaining portion of the screened character content in an arbitrary arrangement and combination, and allowing the plurality of characters to set arbitrarily the foreground color and the background color therefor to serve as the exclusive verification code.

4. The verification code generating system as claimed in claim 1, wherein the error-prone message further comprises a weight for each of a plurality of characters, the weight being served as a basis for screening out the plurality of characters.

5. The verification code generating system as claimed in claim 1, wherein the record module stopping recording the difference to the error-prone message corresponding to the account when a total character number of the difference between the verification code message and the verification code goes beyond a predetermined proportion, the predetermined proportion being allowed to be adjusted after the account logins.

6. A verification code generating method comprising steps of:
storing at least an account therein, each of the account comprising an error-prone message;
generating and displaying a verification code and receiving a verification code message;
recording a difference between the verification code message and the verification code, if the difference exists, into the error-prone message corresponding to the account when a user logins one of the account; and
generating an exclusive verification code according to the error-prone message of the account when the user logins the same account, and using the exclusive verification code as the verification code to be display.

7. The verification code generating method as claimed in claim 6, wherein the error-prone message comprises a character, a number, a symbol, and a color, the color comprising a foreground color and a background color.

8. The verification code generating method as claimed in claim 6, wherein the exclusive verification code formed by re-arranging and combining a remaining portion of a plurality of characters of the error-prone message of the account, and allowing the exclusive verification code to set arbitrarily the foreground color and the background color.

9. The verification code generating method as claimed in claim 6, wherein the error-prone message further comprises a weight for each of a plurality of characters, the weight being served as a basis for screening out the plurality of characters.

10. The verification code generating method as claimed in claim 6, further comprising a step of stopping recording the difference to the error-prone message corresponding to the account when a total character number of the difference between the verification code message and the verification code goes beyond a predetermined proportion, the predetermined proportion being allowed to be adjusted after the account logins.
